(19) United States
(12) Patent Application Publication
(10) Pub. No.: US 2011/0036517 A1
(43) Pub. Date: Feb. 17, 2011

(54) SAFETY DEVICE FOR ROLLER BLIND BEAD CHAIN

(75) Inventor: Ju-Huai Chen, Changhua County (TW)

Correspondence Address: APEX JURIS, PLLC, 12733 LAKE CITY WAY NORTHEAST, SEATTLE, WA, 98125, US

(73) Assignee: MY HOME GLOBAL COMPANY, Changhua Country (TW)

(21) Appl. No.: 12/611,829

(22) Filed: Nov. 3, 2009

(30) Foreign Application Priority Data
Aug. 13, 2009 (TW) 098214944

(51) Int. Cl. E06B 9/56

(52) U.S. Cl. 160/319

(57) ABSTRACT

A safety device for roller shade bead chain includes a connecting seat, a rotary disc disposed atop the connecting seat and provided along a circumferential face with a plurality of retaining recesses, an elastic element located between the connecting seat and the rotary disc, and a cover plate assembled to the connecting seat to restrict the rotary disc and the elastic element to the connecting seat. A bead chain for controlling a roller shade can be wound around the rotary disc, and then pulled into a straight state before the connecting seat is fixed to a predetermined position. The bead chain being pulled straight and held in place via the safety device will not swing freely to dangerously entangle with and strangulate a child, and is therefore safer for use.

### CROSS-REFERENCE TO RELATED APPLICATIONS

This non-provisional application claims priority under 35 U.S.C. §119(a) on Patent Application No(s). 098214944 filed in Taiwan, R.O.C. on 13 Aug. 2009, the entire contents of which are hereby incorporated by reference.

### FIELD OF THE INVENTION

The present invention relates to a safety device for roller shade bead chain, and more particularly to a safety device that is able to hold a bead chain of a roller shade in a straight state and to a fixed position without the risk of swinging freely, and is therefore safer and more convenient for use.

### BACKGROUND OF THE INVENTION

Generally, a roller shade includes a roller connected to an upper end of the roller shade, and a looped bead chain connected to an end of the roller. When the bead chain is pulled, the roller is brought to rotate and accordingly, winds and lifts or releases and lowers the roller shade to a desired height.

While the conventional bead chain can be pulled to rotate the roller and thereby lift or lower the roller shade to a desired height, the bead chain is usually freely hung from the end of the roller without being held to a fixed position. Therefore, the looped bead chain tends to dangerously entangle with and strangulate a child playing around the roller shade. Further, the bead chain is subject to swing and tangle with itself under strong wind or other external force, making the bead chain inconvenient for use.

It is therefore desirable and tried by the inventor to develop a safety device for roller shade bead chain, so that the bead chain for controlling the roller shade can be normally held in a fixed position without swinging freely, so that the bead chain will not entangle with and strangulate a child and is safer and more convenient for use.

### SUMMARY OF THE INVENTION

A primary object of the present invention is to provide a safety device for roller shade bead chain, so that a bead chain for a roller shade can be wound around the safety device to be held in a straight state and to a fixed position without the risk of swinging freely, making the bead chain safer and more convenient for use.

To achieve the above and other objects, the safety device for roller shade bead chain according to the present invention includes a connecting seat, a rotary disc disposed atop the connecting seat and provided along a circumferential face with a plurality of retaining recesses, an elastic element located between the connecting seat and the rotary disc, and a cover plate assembled to one face of the connecting seat to restrict the rotary disc and the elastic element to the connecting seat.

A looped bead chain for controlling a roller shade can be wound around the rotary disc, and is then pulled into a straight state before the connecting seat of the safety device is fixed to a predetermined position opposite to the roller of the roller shade. After being pulled straight and held in place via the safety device, the bead chain will not swing freely to dangerously entangle with and strangulate a child, and is therefore safer for use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled view of a safety device for roller shade bead chain according to an embodiment of the present invention;

FIG. 2 is an exploded perspective view of FIG. 1;

FIG. 3 schematically shows the application of the safety device for roller shade bead chain of the present invention; and

FIG. 4 is a sectioned side view showing the safety device for roller shade bead chain of the present invention in use.

### DETAILED DESCRIPTION OF THE PREFERRED EMBODIMENTS

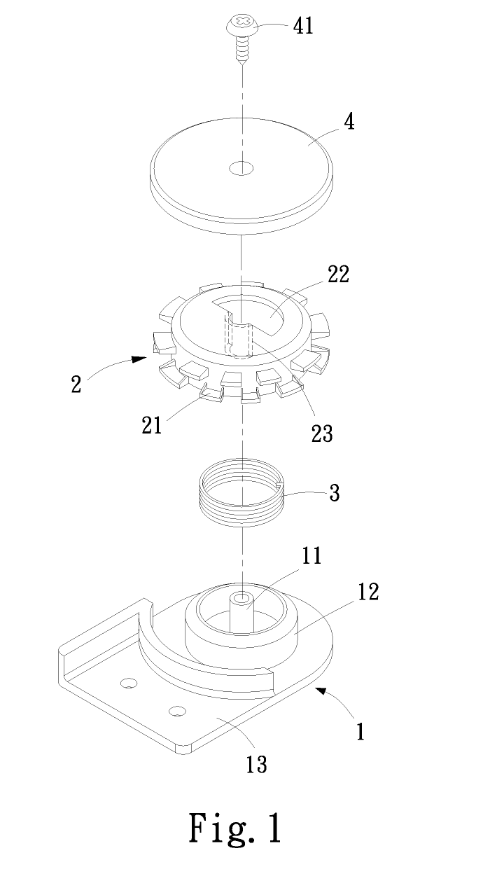

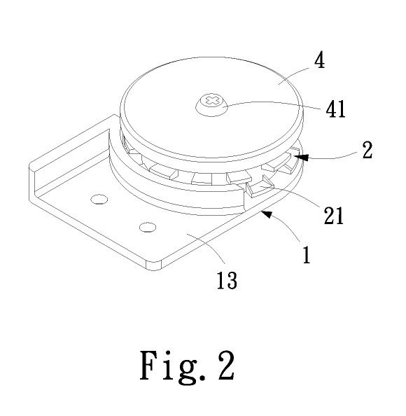

Please refer to FIGS. 1 and 2 that are assembled and exploded perspective views, respectively, of a safety device for roller shade bead chain according to an embodiment of the present invention. For the purpose of conciseness, the present invention is also briefly referred to as the safety device herein. As shown, the safety device includes a connecting seat 1, a rotary disc 2, an elastic element 3, and a cover plate 4.

The connecting seat 1 is provided at a center with a post 11 projected from one face thereof, and a sleeve 12 coaxially positioned around the post 11. A mounting plate 13 is extended from one side of the connecting seat 1. The mounting plate 13 can be a flat plate or an L-shaped plate.

The rotary disc 2 is disposed atop the connecting seat 1, and is provided along an outer circumferential face with a plurality of retaining recesses 21. The rotary disc 2 has a central opening 22 and a guide rod 23 located to one side of central opening 22 to extend from one face of the rotary disc 2. The rotary disc 2 disposed atop the connecting seat 1 is fitted around and above the sleeve 12 with the central opening 22 engaged with the post 11 and the guide rod 23 extended into the sleeve 12.

The elastic element 3 is fitted in the sleeve 12 to locate between the connecting seat 1 and the rotary disc 2, such that the elastic element 3 interferes with the guide rod 23.

The cover plate 4 is assembled to the face of the connecting seat 1 with the sleeve 12 by a fastening element 41 secured to the post 11, so that the cover plate 4 is covered onto the rotary disc 2 to close the central opening 22 and the elastic element 3 is confined in between the rotary disc 2 and the sleeve 12.

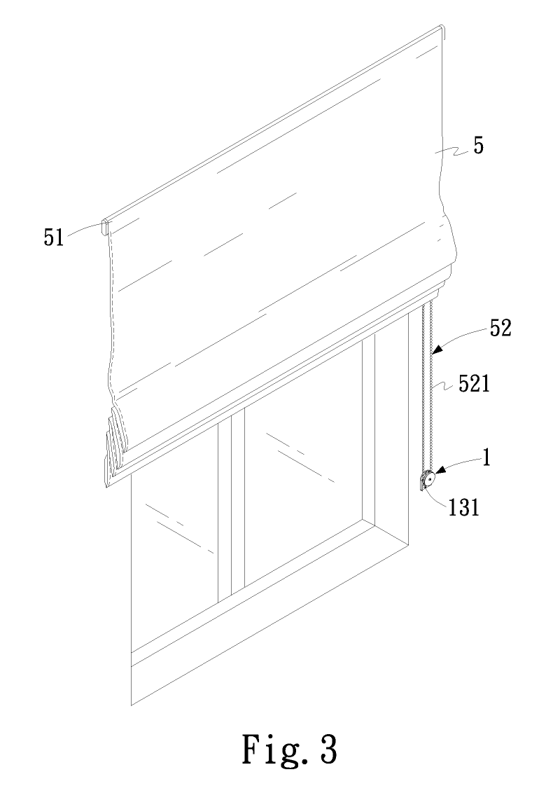

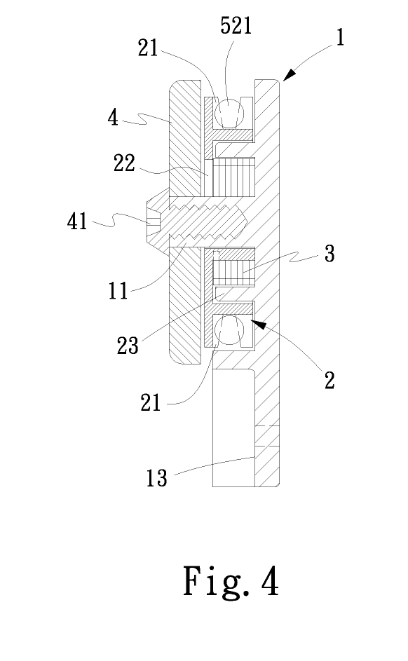

Please refer to FIG. 3 that shows the application of the safety device of the present invention, and to FIG. 4 that is a sectioned side view showing the safety device in use. As shown, a roller shade 5 is provided at an upper end with a roller 51, and a looped bead chain 52 formed from a plurality of beads 521 is connected to an end of the roller 51. To use the safety device, first extend the bead chain 52 to wind it around the rotary disc 2 with the beads 521 in contact with the rotary disc 2 separately movably set in the retaining recesses 21. Then, assemble the cover plate 4 to the connecting seat 1 by securing the fastening element 41 to the post 11, so that the cover plate 4 closes the central opening 22 of the rotary disc 2, the elastic element 3 is confined in between the rotary disc 2 and the sleeve 12 on the connecting seat 1, and the beads 521 are restricted within the retaining recesses 21. Thereafter, the looped bead chain 52 is pulled into a straight state and the mounting plate 13 provided at one side of the connecting seat 1 is fixedly mounted via fastening elements 131 to a wall surface at a position opposite to and distant from the roller 51, so that the bead chain 52 is held in place and in the straight state without the risk of swinging freely. Therefore, the danger of having a child entangled and strangulated by a freely swinging looped bead chain is avoided, and the roller shade bead chain is safe for use.

When it is desired to lift or lower the roller shade 5, simply pull the looped bead chain 52 in a correct direction. At this point, the beads 521 in the retaining recesses 21 drive the rotary disc 2 to rotate, such that the pulled bead chain 52 brings the roller 51 to rotate. Meanwhile, with the help of the elastic element 3, a user can well feel the rotating of the rotary disc 2 under driving by the beads 521 in the retaining recesses 21. When the roller shade 5 has been lifted or lowered to a desired height, the bead chain 52 can be released. At this point, the elastic element 3 can elastically hold the guide rod 23 of the rotary disc 2 in place, so that the beads 521 are restricted within the retaining recesses 21, preventing the bead chain 52 against pulling by the weight of the roller shade 5 and accordingly, the risk of automatic lowering of the roller shade 5. Therefore, the roller shade 5 and the bead chain 52 are more convenient and safe for use.

In the present invention, since the looped bead chain is wound around the rotary disc and pulled into a straight state before the connecting seat is mounted to a fixed position on a wall surface, the bead chain will not swing freely or entangle with a child to dangerously strangulate the child. Therefore, the safety device for roller shade bead chain according to the present invention is novel and improved for safe and convenient use. And, the safety device of the present invention is industrially valuable because products derived from the present invention will no doubt meet the market demands.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A safety device for roller shade bead chain, comprising:
a connecting seat;
a rotary disc being disposed atop the connecting seat, and being provided along a circumferential face with a plurality of retaining recesses;
an elastic element being located between the connecting seat and the rotary disc; and
a cover plate being assembled to one face of the connecting seat to restrict the rotary disc and the elastic element to the connecting seat.

2. The safety device for roller shade bead chain as claimed in claim 1, wherein the connecting seat is provided at a center with a post projected from the face of the connecting seat facing toward the cover plate, and a sleeve coaxially located around the post, and a mounting plate extended from one side of the connecting seat; and wherein the rotary disc has a central opening and a guide rod located to one side of central opening to extend from one face of the rotary disc, such that the rotary disc disposed atop the connecting seat is located around the sleeve with the central opening engaged with the post and the guide rod extended into the sleeve; and wherein the elastic element is fitted in the sleeve and interferes with the guide rod.

3. The safety device for roller shade bead chain as claimed in claim 2, wherein the mounting plate is selected from the group consisting of a flat plate and an L-shaped plate.

4. The safety device for roller shade bead chain as claimed in claim 1, wherein the cover plate is assembled to the connecting seat via a fastening element.
